(19) United States
(12) Patent Application Publication
(10) Pub. No.: US 2011/0043523 A1
(43) Pub. Date: Feb. 24, 2011

(54) GRAPHICS PROCESSING APPARATUS FOR SUPPORTING GLOBAL ILLUMINATION

(75) Inventors: Do Hyung KIM, Daejeon (KR); Bon Ki KOO, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/788,596

(22) Filed: May 27, 2010

(30) Foreign Application Priority Data
Aug. 24, 2009 (KR) 10-2009-0078015

(51) Int. Cl. G06T 15/50; G09G 5/36

(52) U.S. Cl. 345/426; 345/545

(57) ABSTRACT

Provided is a graphics processing apparatus. The graphics processing apparatus minimizes the change of the pipeline structure of the existing graphics processing apparatus, enabling compatibility with the existing API. Simultaneously, by calculating the brightness value or color value of the face of an object according to a global illumination scheme, the graphics processing apparatus can provide realistic image videos. Moreover, the graphics processing apparatus generates an image video based on a local illumination scheme through the existing GPU and simultaneously provides a global illumination effect only for a desired region, thereby improving the entire processing speed of a system.

### CROSS-REFERENCE TO RELATED APPLICATIONS

This application claims priority under 35 U.S.C. §119 to Korean Patent Application No. 10-2009-0078015, filed on Aug. 24, 2009, in the Korean Intellectual Property Office, the disclosure of which is incorporated herein by reference in its entirety.

### TECHNICAL FIELD

The following disclosure relates to a graphics processing apparatus, which performs a rendering operation.

### BACKGROUND

A Graphics Processing Unit (GPU) is the most core apparatus for implementing a multimedia environment. A graphics processing technology that is performed in the GPU may be largely categorized into an animation technology and a rendering technology.

An animation processing operation is a technology that allows to move the shape of an object per frame. The rendering technology is one that dyes color on the surface of an object.

Particularly, the rendering technology is a very difficult technology field that requires sufficient understanding for the dispersion and refraction of light that occur by an object on which light is irradiated and sufficient understanding for the optical attribute of light. As one field for such a rendering technology, there are a local illumination-based rendering technology (hereinafter referred to as a local illumination scheme) and a global illumination-based rendering technology (hereinafter referred to as a global illumination scheme).

The existing GPU adopts the graphics processing scheme of the local illumination scheme that calculates the brightness value of face of an object, in consideration of only the relationship between the normal vector of a vertex and light (i.e., direct relationship between a user, a light source and an object). However, since the local illumination scheme does not consider indirect illumination based on a peripheral environment that surrounds a face, it cannot take light effects such as shadows. For restrictively solving such limitations, the local illumination scheme imitates the light effect through shadow mapping and imitates a reflection effect through environment mapping. Because the local illumination scheme that is implemented in this way cannot better reflect optical characteristic than result materials that are generated by the global illumination scheme, it provides low reality. Moreover, the local illumination scheme requires a separate operation procedure in a rendering operation.

On the other hand, the global illumination scheme takes light effects in consideration of a peripheral environment that surrounds a face and a face, the optical attribute of light and the relationship between these. Accordingly, since realistic optical effects such as the generation and reflection of shadows are reflected in videos, the global illumination scheme provides image videos having high reality relative to the local illumination scheme. As a representative example of the global illumination scheme, there is a ray tracing scheme. As the other examples of the global illumination scheme, furthermore, there are a radiosity or radiance cache scheme and a photon map ray tracing scheme.

The global illumination scheme requires much operation amount for providing image videos having reality. That is, because a global illumination-based rendering technology requires more operation amount than a local illumination-based rendering technology, it has difficulty in processing in real time.

As a scheme that is being tried for operating global illumination, there is a scheme in which a central processing unit (CPU) operates global illumination, a scheme that maps a global illumination operation algorithm in the existing GPU structure or a plan that develops dedicated hardware.

The scheme in which the CPU operates global illumination increases the processing load of the CPU, and consequently, it decreases the execution speed of other application programs to be processed by the CPU.

The scheme that maps the global illumination operation algorithm in the existing GPU structure rather decreases a performance speed than a CPU-based operation because of a bottleneck that occurs in data communication between the CPU and the GPU.

As dedicated hardware, therefore, a Ray Processing Unit (RPU) that may perform the global illumination scheme in real time is being developed. The RPU has been disclosed in the paper entitled “A Hardware Architecture for Ray Tracing” presented by Jorg Schmitter, Ingo Wald and Philipp Slusallek.

However, since the dedicated hardware has a hardware structure that differs from that of the existing GPU, it requires a new graphics driving application program interface, which is different from the existing graphics driving application program interface (API), such as “OpneRT” being SDK that is used the above-described paper.

Due to this reason, the existing graphics application program cannot drive in new hardware or slowly drives through emulation.

For simply driving a graphics application program in new dedicated hardware that supports global illumination or using the function of new global illumination hardware, programs should be rewritten based on a new graphics driving application program interface. This causes a limitation that nontechnical users should have both the existing hardware and hardware that supports global illumination and a limitation that development companies should learn a new program interface technology and newly redevelop programs.

### SUMMARY

In one general aspect, a graphics processing apparatus includes: a global illumination operation unit calculating a global illumination operation value for a first object; and a local illumination operation unit fetching the global illumination operation value by using a global illumination operation value loader instruction, and shading the value in a pixel value of the first object to output a final pixel value.

In another general aspect, a graphics processing apparatus includes: a global illumination operation unit calculating a global illumination operation value for a first object; and a local illumination operation unit fetching a global illumination operation value which is stored in a texel value type by using a texture loader instruction, and shading the fetched value in a pixel value of the first object to output a final pixel value.

In another general aspect, a graphics processing apparatus includes: a local illumination operation unit performing a local illumination operation to output a first pixel value in which a local illumination operation value is reflected; a global illumination operation unit performing a global illumination operation to output a global illumination operation value; a global frame buffer unit storing a second pixel value in which the global illumination operation value is reflected; and an integrated frame buffer unit receiving the first pixel value from the local illumination operation unit and the second pixel value from the global frame buffer unit, and combining the first and second pixel values to store a final pixel value.

Other features and aspects will be apparent from the following detailed description, the drawings, and the claims.

### BRIEF DESCRIPTION OF THE DRAWINGS

FIG. 1 is a block diagram illustrating the entire configuration of a graphics processing system according to an exemplary embodiment.

FIG. 2 is a block diagram specifically illustrating a graphics processing apparatus in FIG. 1.

FIG. 3 is a block diagram illustrating a graphics processing apparatus according to another exemplary embodiment.

FIG. 4 is a block diagram illustrating a graphics processing apparatus according to another exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

The present invention secures the operation of the existing graphics driving program interface (API) and simultaneously proposes a graphics processing apparatus for supporting global illumination. That is, a graphics processing apparatus according to an exemplary embodiment store global illumination operation values in a texel value type and support global illumination using a texture loader instruction being an instruction which enables to fetch the existing texel value. A graphics processing apparatus according to another exemplary embodiment respectively store a global illumination operation value and a local illumination operation value, which are calculated through a separate pipeline, in different frame buffers and combines the values, thereby supporting global illumination. A graphics processing apparatus according to another exemplary embodiment add a new instruction (for example, a Global Illumination Intensity Loader (GILD)) to the existing pixel shader (or a fragment shader) and fetch a global illumination operation value, thereby supporting global illumination.

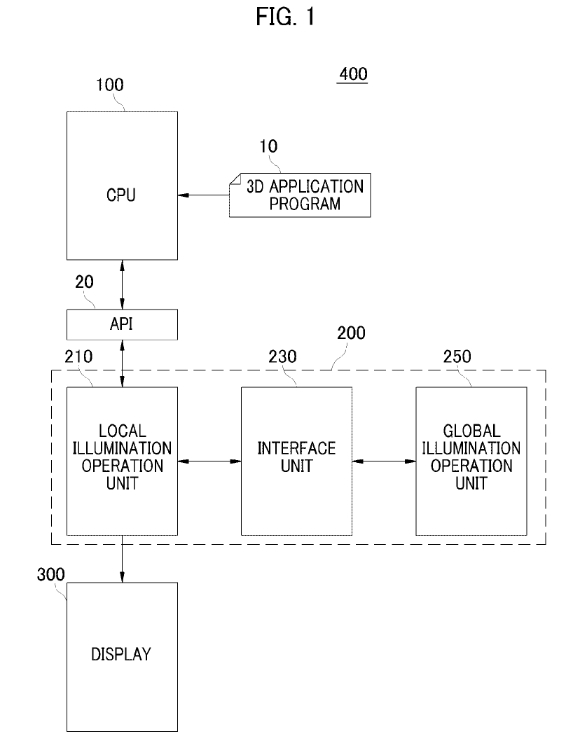

FIG. 1 is a block diagram illustrating the entire configuration of a graphics processing system according to an exemplary embodiment.

Referring to FIG. 1, a graphics processing system 400 according to an exemplary embodiment includes a central processing unit (CPU) 100, a graphics processing apparatus 200, and a display 300.

When a predetermined Three-Dimensional (3D) application program is executed, the CPU 100 divides objects, which are included in a scene that is displayed to a user through an Application Program Interface (API) 20 based on the existing direct X or an Open Graphics Library (OpenGL), into the sets of polygons having a triangular shape. Herein, the polygon denotes a multi-angle shape being the smallest unit that is used in an operation of representing a three-dimensional shape in 3D computer graphics. Moreover, the CPU 100 outputs the geometric information of the polygon, which represents each set, to the graphics processing apparatus 200.

The graphics processing apparatus 200, as described above, performs local illumination operation processing on the basis of the geometric information of each volume that is outputted from the CPU 100, and performs global illumination operation processing when necessary. For example, the graphics processing apparatus 200 performs global illumination operation processing on an object (or a region) requiring global illumination. The graphics processing apparatus 200 outputs a local illumination video, on which local illumination operation processing is performed, to the display 300, or combines the local illumination video and a global illumination operation processing result to output the final video to the display 300. Herein, the local illumination video may be a pixel value in which a local illumination effect is reflected, and the final video may denote a pixel value in which the local illumination effect is reflected and a pixel value in which the global illumination effect is reflected.

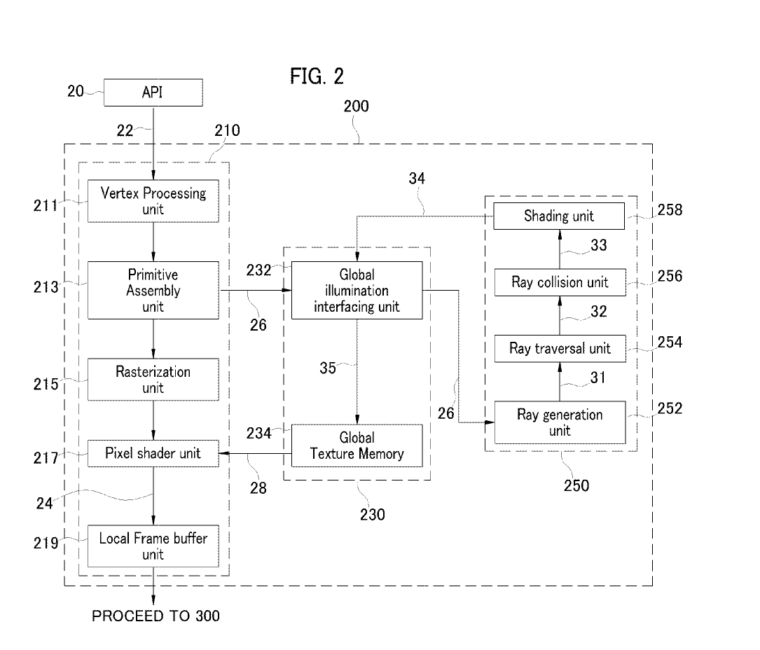

FIG. 2 is a block diagram specifically illustrating the graphics processing apparatus in FIG. 1.

Referring to FIG. 2, the graphics processing apparatus 200 may include a local illumination operation unit 210, a global illumination operation unit 250, and an interface unit 230 that connects the local illumination operation unit 210 and the global illumination operation unit 250 in hardware.

The local illumination operation unit 210 may include a vertex processing unit 211, a primitive assembly unit 213, a rasterization unit 215, a pixel shader unit 217, and a local frame buffer unit 219.

The shapes of objects to be represented by a user may be divided into the sets of polygons having a triangular shape. The polygon of the each set has three angular points, which are called vertexes.

The vertex processing unit 211 receives a vertex data 22, which includes the coordinates (i.e., vertices positions) of three vertexes, color, the normal vector of a vertex configuring faces and texture coordinates, from the API 20. The vertex processing unit 211 performs a matrix operation on the received vertex data 22 to determine coordinates on a screen, and determines the brightness of a vertex according to a illumination model. In the vertex processing unit 211, an operation that changes from a model coordinate system to a screen coordinate system and an operation of calculating illumination are divided.

The operation, which changes from the model coordinate system to the screen coordinate system, changes from a coordinate system (where the center of a model is processed as the origin) in which models are defined to a world coordinate system being the coordinate system of a virtual world in which many models exist together. That is, the points of the world coordinate system are acquired through processing operations such as the movement, rotation and size control of points on the model coordinate system.

The points on the world coordinate system are view changed to a view coordinate system being a coordinate system about a camera. The view coordinate system is projection changed to a projection coordinate system being a coordinate system which corresponds to a perspective projection result. Herein, the projection change is an operation that makes X and Y coordinates small as points on the view coordinate system become farther away from the origin. Furthermore, by performing size change according to the size of a screen to be actually represented, coordinate change is achieved to points on a Two-Dimensional (2D) screen coordinate system.

A illumination calculation operation is one that sums ambient light being the component of light that light reflected by another peripheral object affects indirectly, diffusion light being the component of light that is diffused and reflected on the surface of an object and specular light which has a specific direction and is reflected on the surface of an object, thereby determining vertex color.

The primitive assembly unit 213 gathers points, on which the coordinate change operation and the illumination calculation operation are terminated by the vertex processing unit 211, to generate a geometric object, for example, a triangular data. When an object requires a global illumination effect or a user intends to provide a global illumination effect to a specific object, the primitive assembly unit 213 transfers an object or information on the object to the interface unit 230. At this point, the primitive assembly unit 213 may determine whether an object is for a global illumination operation. For example, this may be determined from the attribute of the object. Alternatively, the primitive assembly unit 213 does not perform the determination, and may transfer the object to the interface unit 230 according to the control or command of the pixel shader unit 217 that will be described below.

The interface unit 230 transfers the object, which is transferred from the primitive assembly unit 213, to the global illumination operation unit 250. Herein, the interface unit 230 may transfer 3D information for the object, for example, X, Y and Z values which are the 3D information of a triangle before projection change and the 2D information of a triangle after projection change, i.e., X′ and Y′ values that represent the degree which is projected in two dimensions. The global illumination operation unit 250 will be described below.

The rasterization unit 215 determines pixel values that configure an object on a screen.

The pixel shader unit 217 performs a fragment processing operation on the pixel values that is determined through the rasterization unit 215.

Specifically, the pixel shader unit 217 shades a local illumination operation value in the pixel value of an object through the fragment processing operation when the local illumination operation value for the local illumination effect of the object is calculated. Moreover, the pixel shader unit 217 fetches a texel value of the object from a texture map and shades the texel value in a pixel value in which the local illumination operation value is reflected. Herein, the texel value may be a value about the texture and pattern of the object. The pixel shader unit 217 fetches a local illumination texel value from a local texture map by using a texture loader instruction. The texture map may be included outside the pixel shader unit 230. Herein, the texture loader instruction may be as follows.
text1d dst, src0, src1
   where dst is a destination register, src0 is a source register that provides texture coordinates for a texture sample, and src1 is a texture number (i.e., src1 identifies a sampler (Direct3D 9 asm-ps) (s#), wherein # specifies a texture sampler number to sample).

For an object requiring a global illumination effect, the pixel shader unit 217 fetches a global illumination operation value 28, which is stored in a texel value type, using a texture loader instruction which is the same as an instruction for fetching a local illumination texel value, and shades the value 28 in the pixel value of the object to output the final video. For example, the pixel shader unit 217 may set the src1 being the texture number among the instructions (for example, tex1d dst, src0 and src1) as another value and fetch the global illumination operation value 28, which is stored in the texel value type, from the texture memory 234. Herein, the pixel shader 217 may determine whether the object requires the global illumination effect through the attribute of the object.

Information on whether to perform a global illumination operation for an object is added to the object and transferred to the graphics processing apparatus 200 by the API 20. Based on the transferred information, an object for global illumination and information for global illumination calculation, for example, information on a ray or a virtual camera are transferred to a global illumination interface unit 232 by the primitive assembly unit. 213, and a global illumination operation value for a corresponding object is calculated in advance and stored in a global illumination texture memory 234. A portion or entirety of the stored value is provided to the pixel shader unit 217 and used, depending on the case. When the information on whether to perform the global illumination operation for the object is not transferred to the graphics processing apparatus 200 by the API 20, objects transferred to the local illumination operation unit 210 are simultaneously transferred to the rasterization unit 215 and the global illumination interface unit each time they pass through the primitive assembly unit 213, and information for global illumination calculation is additionally transferred to the global illumination interface unit 232. Accordingly, the global illumination operation unit 250 may recognize an object that is currently being processed by the pixel shader unit 217. When the pixel shader unit 217 requests a value to the global illumination texture memory 234, the global illumination operation unit 250 may calculate a value at a time when the request is received and transfer the calculated value to the pixel shader unit 217 through the global illumination texture memory 234.

When the final pixel value, in which a local illumination operation value and a global illumination operation value are reflected, is stored in the local frame buffer unit 219 and transferred to the display 300, the display 300 provides a realistic output video in which the local illumination operation value and the global illumination operation value are reflected to a user.

Hereinafter, the interface unit 230 in FIG. 2 will be described.

Referring to FIG. 2, the interface unit 230 connects the local illumination operation unit 210 and the global illumination operation unit 250 in hardware. For this, the interface unit 230 may include a global illumination interface unit 232 and a global illumination texture memory 234.

The global illumination interface unit 232 receives information 26 on an object requiring a global illumination effect from the primitive assembly unit 213 and transmits the received information 26 to the global illumination operation unit 250. At this point, the global illumination operation unit 250 receives the information on the object to output a global illumination operation value 34.

The global illumination interface unit 232 receives the global illumination operation value 34 and stores the value 34 in a texel value type in the global illumination texture memory 230.

Hereinafter, the global illumination operation unit 250 in FIG. 2 will be described in detail.

Referring to FIG. 2, a ray tracing algorithm for supporting a global illumination effect (for example, reflection, refraction and shadows) is included in the global illumination operation unit 250 in FIG. 2. The ray tracing algorithm is one that reverse traces rays which moves from a light source to a user. In the real world, many photons that are radiated from the light source scatter by colliding with a target object. People recognize peripheral objects by photons that reach their eyes among the photons. As a result, the number of photons which reach people' eyes is smaller than the number of photons that are generated in the light source. Accordingly, the ray tracing algorithm reverse traces only rays that reach people' eyes to generate an image. Since a ray moves through a straight path when it moves on a space and a ray maintains symmetry between an incident angle and a reflection angle when it meets an object, the moving path of each ray is reverse traced using these viewpoints. The ray tracing algorithm traces one ray or a plurality of rays that passes/pass through each pixel, continuously calculates intersection, reflection, refraction and shadows that occur by a traced ray (or rays), and calculates a result value of the calculation as the pixel value of the final image (or the result value of global illumination).

The global illumination operation unit 250 where the ray tracing algorithm is implemented in hardware, as illustrated in FIG. 2, may include four elements.

Specifically, the global illumination operation unit 250 may include a ray generation unit 252, a ray traversal unit 254, a ray collision unit 256, and a shading unit 258.

The ray generation unit 252 generates a primary ray to a pixel that is disposed in a viewport from a virtual camera, on the basis of the information 26 on an object that is inputted through the global illumination interface unit 232. The ray generation unit 252 generates new rays, for example, a secondary ray, a shadow ray, a reflection ray and a refraction ray each time the ray collides with an object.

The ray traversal unit 254 traverses through which trace the rays have traveled, and manages space information.

The ray collision unit 256 determines whether a ray collides with an object.

The shading unit 258 calculates a shadow value 34 according to whether the ray collides with the object and transfers the calculated shadow value 34 to the global illumination interface unit 232.

Subsequently, the global illumination interface unit 232 stores the calculated shadow value 34 in a texel value type as a global illumination operation value in the global illumination texture memory 234:

In this way, the local illumination operation unit 200 (see FIG. 1) according to an exemplary embodiment includes the interface unit 230 which connects in hardware the local illumination operation unit 210 that provides the existing local illumination effect and the global illumination operation unit 250 that provides a global illumination effect, as illustrated in FIG. 2. The local illumination operation unit 200 fetches a local illumination texel value and a global illumination texel value by using the same texture loader instruction to output the final video in which the local illumination effect and a global illumination effect are reflected.

As a result, by maintaining the pipeline structure of the local illumination operation unit 210 that provides the existing local illumination effect as-is, the local illumination operation unit 200 provides compatibility with a program that has been developed with the existing API such as the direct X or the OpenGL.

Moreover, by simply connecting the local illumination operation unit 210 and the global illumination operation unit 250 in hardware through the interface unit 230, the graphics processing apparatus may be provided that may provide the global illumination effect without changing the design of the existing pipeline structure that supports the local illumination effect.

Because the graphics processing apparatus 400 according to an exemplary embodiment only provides the global illumination effect for a region or an object that is required by a user among an entire image, it has far more excellent performance in an operation processing speed than a related art graphics processing apparatus for supporting only the global illumination effect that requires much operation amount on all objects.

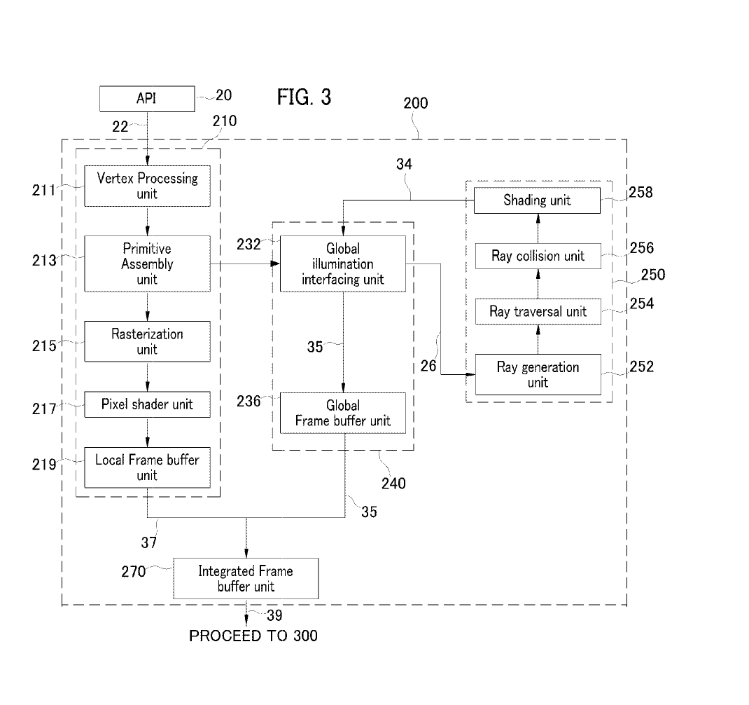

FIG. 3 is a block diagram illustrating a graphics processing apparatus according to another exemplary embodiment.

Referring to FIG. 3, a graphics processing apparatus according to another exemplary embodiment includes a local illumination operation unit 210, an interface unit 240, a global illumination operation unit 250, and an integrated frame buffer unit 270.

The global illumination frame buffer unit 236 stores a global illumination operation value 35 that is transferred from the global illumination interface unit 232. That is, unlike the illustrated in FIG. 2, the global illumination operation value 35 is not stored as a texel value.

The integrated frame buffer unit 270 receives a pixel value in which a local illumination operation value is reflected from a local frame buffer unit 219 in the local illumination operation unit 210, receives a pixel value in which a global illumination operation value is reflected from a global illumination frame buffer 236, and combines the received values to store the final pixel value. The integrated frame buffer unit 270 outputs the final video 39 to the display 300 (see FIG. 1). When the integrated frame buffer unit 270 combines a local illumination video and the global illumination operation value 35, it may perform at least one buffer operation of a COPY operation, an AND operation, an OR operation, an XOR operation, a MULTIPLY operation and a DEVICE operation.

Herein, the global illumination operation unit 250 and the interface unit 240 may perform the above-described operations through a pipeline which differs from that of the local illumination operation unit 210. That is, by generating a local illumination video, generating a global illumination operation value for an object or a region requiring a global illumination effect through another pipeline and preparing the integrated frame buffer unit 270 for combining the local illumination video and the global illumination operation value, the local illumination operation unit 210 and the global illumination operation unit 250 can be simply connected in hardware. By maintaining the pipeline structure of the local illumination operation unit 210 as-is, the graphics processing apparatus according to another exemplary embodiment provides compatibility with a program that has been developed with the existing API such as the direct X or the OpenGL. Because the graphics processing apparatus only provides the global illumination effect for a region or an object that is required by a user, it has more excellent performance in an operation processing speed than a related art graphics processing apparatus for supporting only the global illumination effect that requires much operation.

Alternatively, the global illumination operation unit 250 and the local illumination operation unit 210 may divide a 2D screen into at least two regions and perform a local illumination operation and a global illumination operation on each region or different polygons.

The graphics processing apparatus according to another exemplary embodiment in FIG. 3 excludes the data transmission operation between the pixel shader unit 217 and the global illumination texture memory 234, like in FIG. 2. Accordingly, a waiting time based on the processing operation of the pixel shader unit 217 decreases and thereby an entire processing speed improves, and simultaneously, a pipeline bus structure related to the pixel shader unit 217 is simplified.

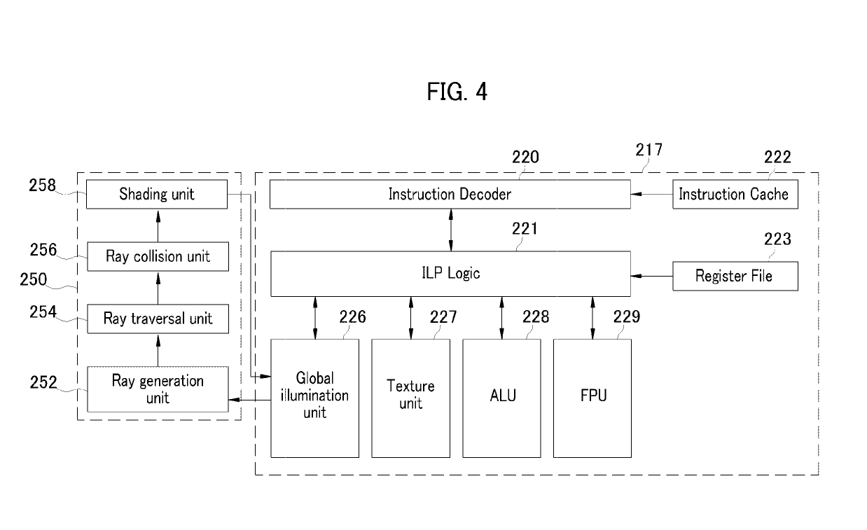

FIG. 4 is a block diagram illustrating a graphics processing apparatus according to another exemplary embodiment.

In FIG. 4, for conciseness, only a global illumination operation unit 250 and a pixel shader unit 217 are illustrated. In this embodiment, the pixel shader unit 217 fetches a global illumination operation value by using a global illumination operation value loader instruction (i.e., a Global Intensity Loader (GILD)) being a new instruction. A detailed description on this is made below.

For performing a fragment processing operation, the pixel shader unit 217 in FIG. 4 includes an instruction decoder 220 and an Instruction Level Parallelism (ILP) logic 221. The instruction decoder 220 receives an instruction from an instruction cache 222 that drives as a high-speed buffer, and decodes the instruction before the instruction is executed. The ILP logic 221 processes an instruction in parallel using the decoded instruction and a register file 223.

Moreover, the pixel shader unit 217 may include an arithmetic and logic unit (ALU) 228 that is connected to the ILP logic 221 in parallel for receiving instructions that are processed in parallel by the ILP logic 221, a floating point unit (FPU) 229, a global illumination interface unit 226, and a texture unit 227.

The global illumination interface unit 226 is included in the pixel shader unit 217.

In the case of an object requiring global illumination, for example, in a case where a global illumination operation value loader instruction is inputted, the input instruction is decoded by the instruction decoder 220, and the decoded instruction is transferred to the global illumination interface unit 226 through the ILP logic 221.

The global illumination interface unit 226 interfaces the pixel shader unit 217 and the global illumination operation unit 250. The global illumination interface unit 226 commands the global illumination operation unit 250 to perform a global illumination operation for an object requiring the global illumination operation, and receives a global illumination operation value that is calculated by the global illumination operation unit 250.

In this way, the pixel shader unit 217 receives the global illumination operation value from the global illumination operation unit 250 and shades the received value in the pixel value of a corresponding object to output the final pixel value.

That is, the pixel shader unit 217 may fetch the global illumination operation value by using a local illumination operation value loader instruction (i.e., Global Illumination based Intensity Loader (GILD)) and perform shading.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A graphics processing apparatus, comprising:
a global illumination operation unit calculating a global illumination operation value for a first object; and
a local illumination operation unit fetching the global illumination operation value by using a global illumination operation value loader instruction, and shading the global illumination operation value in a pixel value of the first object to output a final pixel value.

2. The graphics processing apparatus of claim 1, wherein the local illumination operation unit calculates a local illumination operation value for a second object and shades the calculated value in a pixel value of the second object.

3. The graphics processing apparatus of claim 1, wherein the local illumination operation unit comprises an interface unit which commands the global illumination operation unit to calculate the global illumination operation value for the first object and fetches the calculated global illumination operation value from the global illumination operation unit, when the global illumination operation value loader instruction is inputted.

4. The graphics processing apparatus of claim 3, wherein the local illumination operation unit calculates a local illumination operation value for a second object and shades the calculated value in a pixel value of the second object

5. The graphics processing apparatus of claim 4, further comprising a pixel shading unit fetches a texel value for the second object by using a texture loader instruction and shades the texel value in a pixel value in which the local illumination operation value for the second object is reflected

6. A graphics processing apparatus, comprising:
a global illumination operation unit calculating a global illumination operation value for a first object; and
a local illumination operation unit fetching a global illumination operation value which is stored in a texel value type by using a texture loader instruction, and shading the fetched value in a pixel value of the first object to output a final pixel value.

7. The graphics processing apparatus of claim 6, wherein the local illumination operation unit comprises:
a primitive assembly unit transferring information on the first object to the global illumination operation unit; and
a pixel shader unit fetching the texel value type of global illumination operation value.

8. The graphics processing apparatus of claim 7, wherein:
the primitive assembly unit determines whether the first object is for a global illumination operation and transfers the information on the first object to the global illumination operation unit, and
the global illumination operation unit performs the global illumination operation when the information on the first object is received.

9. The graphics processing apparatus of claim 7, wherein:
the pixel shader unit determines whether the first object is for a global illumination operation to request the global illumination operation to the global illumination operation unit, and
the global illumination operation unit performs the global illumination operation when the request is received.

10. The graphics processing apparatus of claim 7, wherein the pixel shader unit fetches a texel value for a second object by using the texture loader instruction and shades the texel value in a pixel value in which the local illumination operation value for the second object is reflected.

11. The graphics processing apparatus of claim 10, wherein:
the global illumination operation unit calculates the global illumination operation value for the first object requiring global illumination, and
the local illumination operation unit calculates the local illumination operation value for the second object requiring local illumination.

12. The graphics processing apparatus of claim 6, wherein:
the local illumination operation unit performs shading through fragment processing, and
the global illumination operation unit calculates the global illumination operation value through a ray tracing algorithm.

13. The graphics processing apparatus of claim 6, further comprising:
a global illumination texture memory storing the global illumination operation value in the texel value type; and
an interface unit receiving information on the first object to transfer the received information to the global illumination operation unit, and transfers the calculated global illumination operation value to the global illumination texture memory.

14. A graphics processing apparatus, comprising:
a local illumination operation unit performing a local illumination operation to output a first pixel value in which a local illumination operation value is reflected;
a global illumination operation unit performing a global illumination operation to output a global illumination operation value;
a global frame buffer unit storing a second pixel value in which the global illumination operation value is reflected; and
an integrated frame buffer unit receiving the first pixel value from the local illumination operation unit and the second pixel value from the global frame buffer unit, and combining the first and second pixel values to store a final pixel value.

15. The graphics processing apparatus of claim 14, wherein the local illumination operation unit and the global illumination operation unit operate with different pipelines.

16. The graphics processing apparatus of claim 14, wherein the local illumination operation unit and the global illumination operation unit divide a two-dimensional screen into at least two regions and perform the local illumination operation and the global illumination operation on each region or different polygons, respectively.

17. The graphics processing apparatus of claim 14, further comprising an interface unit receiving an object for the global illumination operation from the local illumination operation unit to transfer the received object to the global illumination operation unit, and outputting the global illumination operation value to the integrated frame buffer unit.

18. The graphics processing apparatus of claim 14, wherein the integrated frame buffer unit performs at least one buffer operation of a COPY operation, an AND operation, an OR operation, an XOR operation, a MULTIPLY operation and a DEVICE operation.
